(19) United States
(12) Patent Application Publication
(10) Pub. No.: US 2017/0046648 A1
(43) Pub. Date: Feb. 16, 2017

(54) Method for automatically determining recommendation(s) of Action(s) to make to persons of an organization, and associated computing apparatus

(71) Applicants: Michael BENTOLILA, Neuilly sur Seine (FR); Yohan BENTOLILA, Neuilly sur Seine (FR)

(72) Inventor: Yohan BENTOLILA, Neuilly sur Seine (FR)

(21) Appl. No.: 15/233,148

(22) Filed: Aug. 10, 2016

(30) Foreign Application Priority Data
Aug. 10, 2015 (FR) 1557637

(51) Int. Cl. G06Q 10/06; G06F 7/02

(52) U.S. Cl. CPC G06Q 10/06316; G06F 7/026

(57) ABSTRACT

A method includes a first step where one determines for each person of an organization a category to which he belongs taking account of his participation level in the deployment of a change, then values representative of a common point existing between a chosen person and the other persons of the organization, and a second step where one determines a group of recommendations of action(s) to make to this chosen person taking account of the category to which he belongs, then for each recommendation of action(s) of the group one determines among persons having an important relationship therewith a sub-group of persons having the highest values, then one estimates for each recommendation of action(s) of the group a score as a function of the values associated with the persons belonging to the sub-group, then one selects among the recommendations of action(s) of the group that having the highest score in order that it is made to the chosen person.

### CROSS-REFERENCE TO RELATED APPLICATIONS

This application claims the priority of French application no. 1557637, filed on the 10 Aug. 2015. The content of this application is incorporated herein by reference in its totality.

### FIELD OF THE INVENTION

The invention relates to the automation of the determination of recommendation(s) of action(s) within organizations in which a change is in the course of deployment.

“Change” is herein taken to mean any modification made within an organization, in particular, but not only, in technical terms, to facilitate the carrying out of operations, or to make available innovations or new services or new functionalities, or to satisfy a new regulation or a new standard, or to impose the use of new software, or to modify a teaching mode, or instead to introduce a new management system, for example of production or of personnel.

Furthermore, “organization” is herein taken to mean any set of persons, organized into a hierarchy or not, and in which several persons may be concerned during a more or less long time interval by the deployment of a change. Consequently, it could be, for example, a firm, a group of firms, an administration, or an association.

### STATE OF THE ART

When an organization deploys a change that concerns a part at least of the persons who constitute it, this frequently takes a long time interval due to the fact that these persons are more or less receptive to the change, either on an ad hoc basis or in a general manner. In fact, it may be observed that in practically any organization the deployment of a change follows a flattened S-shaped (or sigmoid) curve of evolution over time. The persons the most receptive to the change rapidly implement the change requested by their organization and thus are those who participate at the start of the curve, the persons moderately receptive to the change implement at a moderate speed the change requested by their organization and thus are those who participate in the central (or intermediate) part of the curve, and the persons the least receptive to the change slowly implement the change requested by their organization and thus are those who participate at the end of the curve.

In order to reduce the duration of the deployment of a change or the risk of a deployment failure, there exists, for example, a means consisting in detecting the persons who are moderately or slightly receptive to the change by analyzing manually the several information items that are representative of their participation in the deployment, then to act with these detected persons in an individualized manner to convince them to adopt the change or to motivate them to act. This solution proves to be tedious, time-consuming and relatively inefficient, notably due to the fact that the actions undertaken are not always the best suited and/or that most of the persons reticent to the deployment of a change may only be convinced of the interest of the latter by several rare persons with whom they have got on well beforehand and/or in whom they have confidence. In addition, traditional or non-specialized computers or computing systems are not well suited for the implementation or helping in the implementation of changes within an organization.

### SUMMARY OF THE INVENTION

The aim of the invention is notably to improve the situation. In particular, the aspects of the invention described in this application constitute a solution to a technical problem currently faced by organizations and designers in order to determine recommendations appropriate to a change within an organization.

It notably proposes to this end a method intended to enable the automatic determination of recommendation(s) of action(s) to make to persons of an organization during a deployment of a change, and including:
a first step in which one determines for each person a category to which he belongs taking account of a level of his participation in this deployment, then values representative of a common point existing between a chosen person and each of the other persons of the organization, and
a second step in which one determines in a list a group of recommendations of action(s) to make to the chosen person taking account of the category to which he belongs, then for each recommendation of action(s) of the group one determines among persons having an important relationship with this recommendation of action(s) a sub-group of at the most a predefined number of persons having the highest values, then one estimates for each recommendation of action(s) of the group a score that is a function of the values associated with the persons belonging to the determined sub-group, then one selects among the recommendations of action(s) of the group at least that having the highest score in order that it is made to the chosen person.

Hereafter, a given person is considered as having an important relationship with a recommendation relatively to a chosen person if the given person shows an interest for this recommendation above a first predetermined value and proximity with the chosen person above a second predetermined value.

The method according to the invention may comprise other characteristics which may be taken separately or in combination, and notably:
in the first step it is possible to determine at a given instant for each person the category to which he belongs among at least four categories that correspond respectively to four different intervals of level of participation in the deployment, defined by the bounds that are a function of this given instant;
in the first step it is possible to determine for each person the category to which he belongs at a given instant as a function of a difference between his level of participation in the deployment at this given instant and a value at this given instant of a theoretical curve (cd) of the evolution over time of the deployment of the change;
   the theoretical curve (cd) of the evolution over time of the deployment of the change may be defined by the equation cd=(1+e^{-(t-t0)/τ})⁻¹, where t0 is an instant corresponding to half of the deployment and τ is a parameter representative of a time characteristic of the deployment;
in the first step each value, representative of a common point existing between a chosen person and another person of the organization, may be determined by a so-called Pearson correlation method as a function of stored data which are representative of recommendations of action(s) for which the persons of the organization have shown a form of interest;
in the second step it is possible to select among the recommendations of action(s) of the group at least those having the two highest scores;
in the second step, after having selected a recommendation of action(s), it is possible to determine in the sub-group at least one person suited to making this selected recommendation of action(s), then it is possible to propose to each determined person to make this selected recommendation of action(s) to the chosen person;
in a variant or as a complement, in the second step, after having selected a recommendation of action(s), it is possible to propose the latter to the chosen person so that he follows it, for example due to the fact that this recommendation of action(s) has aroused an interest in a person of the sub-group;
in the second step it is possible to determine in the sub-group at least one person as a function of the category to which he belongs and/or of a hierarchic level that he has within the organization and/or of a status that he has within the organization;
in the second step it is possible to associate a weighting coefficient with each person of the sub-group as a function of the category to which he belongs and/or of a hierarchic level that he has within the organization and/or of a status that he has within the organization, and it is possible to estimate each score of each recommendation of action(s) of the group as a function moreover of the weighting coefficients associated with the persons of the sub-group.

The invention also proposes a computer program product including a set of instructions which, when it is executed by a computer (or computing system), is suited to implementing a method of the type of that described above to determine automatically recommendations of action(s) to make to persons of an organization during a deployment of a change.

The invention also proposes a computing apparatus including processing modules arranged, in the presence of an organization including persons involved in a deployment of a change:
to determine for each person a category to which he belongs taking account of a level of his participation in this deployment, then values representative of a common point existing between a chosen person and each of the other persons of the organization,
then to determine in a list a group of recommendations of action(s) to make to this chosen person taking account of the category to which he belongs,
then for each recommendation of action(s) of this group to determine among persons having an important relationship with this recommendation of action(s) a sub-group of at the most a predefined number of persons having the highest values,
then to estimate for each recommendation of action(s) of the group a score as a function of the values associated with the persons belonging to the determined sub-group,
then to select among the recommendations of action(s) of the group at least that having the highest score in order that it is made to the chosen person.

For example, this computing apparatus may be arranged in the form of a server further including communication means suited to being connected to a communication network in order to establish communications with the communicating equipment used by the persons of the organization. In this case, its processing means may be arranged, after having selected a recommendation of action(s), to determine in the sub-group at least one person suited to making this selected recommendation of action(s), then to order the communication means to transmit to each determined person a message containing a proposal to make this selected recommendation of action(s) to the chosen person.

### BRIEF DESCRIPTION OF THE FIGURES

Other characteristics and advantages of the invention will become clear on examining the description detailed hereafter, and the appended drawings, in which:

FIG. 1 schematically and functionally illustrates an example of embodiment of a computing apparatus according to the invention, coupled to a communication network to which are also coupled the communicating equipment of persons of an organization,

FIG. 2 schematically illustrates an example of algorithm implementing a method for automatically determining recommendation(s) of action(s) according to the invention,

FIG. 3 schematically illustrates within a diagram an example of theoretical curve (cd) of the evolution over time of the deployment of a change within an organization,

FIG. 4 schematically illustrates an architecture according to an embodiment of the invention specially configured to determine recommendations of actions, and

FIG. 5 illustrates the interactions between the different modules in an embodiment of the invention.

### DETAILED DESCRIPTION

The aim of the invention is notably to propose a method, and an associated computing apparatus, intended to enable the automatic determination of recommendation(s) of action(s) to make to persons of an organization during a deployment of a change.

Hereafter, it is considered, as a non-limiting example, that the organization is a firm including salaried persons. But the invention is not limited to this type of organization. It relates in fact to any set of persons, organized into a hierarchy or not, and in which several persons may be concerned during a more or less long time interval by the deployment of a change. Consequently, it could also be a group of firms, an administration, a teaching establishment, or an association, for example.

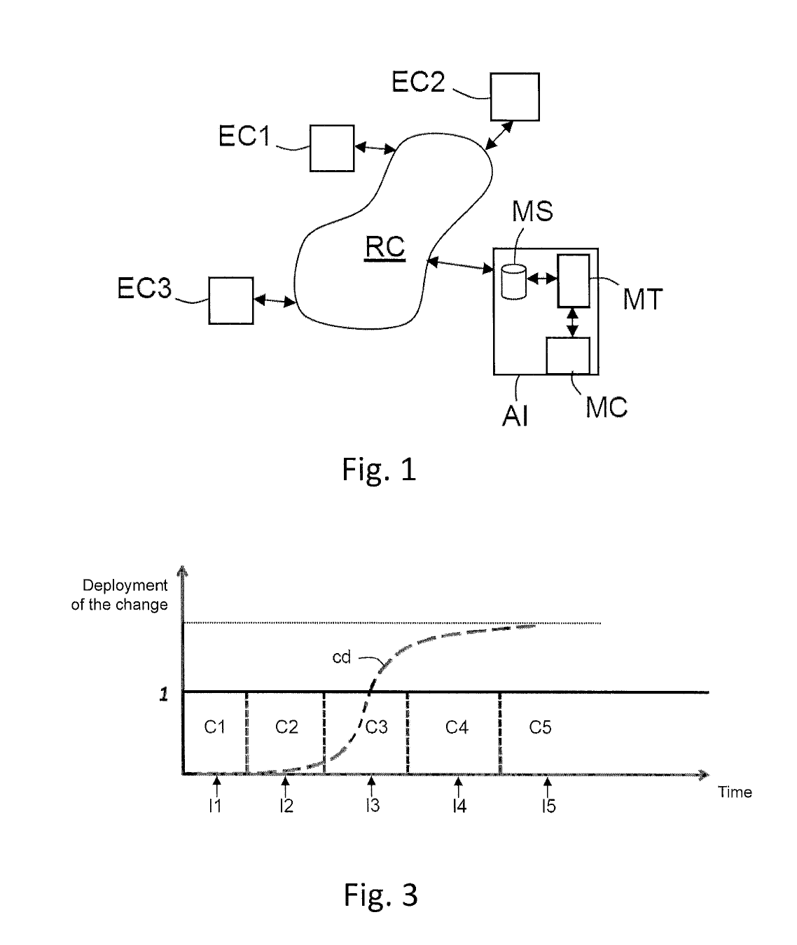

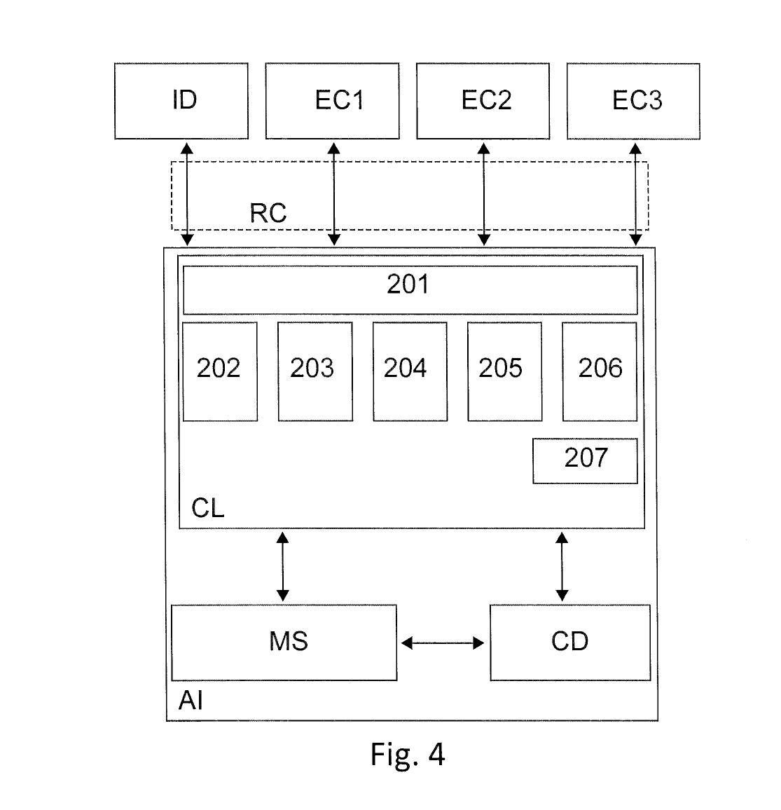

In FIGS. 1 and 4 are schematically and functionally illustrated a communication network RC to which are coupled a computing apparatus AI belonging to an organization (here a firm) and communicating equipment ECj used by persons forming part of the organization. FIG. 4 represents a description of a dedicated computing system AI that is specifically constructed to carry out the method described in the present description. The modules of the computing system AI and their arrangements and functionalities are specifically constructed and designed so that the different modules and components of the computing system AI cooperate to supply recommendations of actions to users/members of an organization during the implementation of a change in the organization in a completely different manner compared to what is usually done by means of a manual approach or a manual approach implemented on a traditional or non-specialized computing system. As will be described hereafter, the method and the computing system AI specifically designed according to the embodiments of the invention supply recommendations of actions different to those that would have been obtained using a conventional approach.

For example, the computer apparatus AI may be a server, potentially Internet (or web). But this is not obligatory. If could also be, for example, a desktop or portable computer or a tablet computer. As will be described hereafter, the network server AI may be a physical server (hardware) that includes a processor, a memory and capacities for communicating with a network. In certain embodiments, the network server AI sends data to and receives data from one or more items of communication equipment or electronic devices of users ECj. Also for example, the communicating equipment ECj, which include notably a memory, a processor, may be desktop or portable computers. But this is not obligatory. They could also be, for example, tablet computers or smartphones, mobile email devices, portable game consoles, e-book readers, televisions with one or more integrated or coupled processors or any electronic device capable of accessing the network RC. In the implementation illustrated in FIG. 1, the users/members interact with the communication apparatus or the user device EC, which is coupled to the network via signal lines (schematically represented by arrows in FIG. 1). In the example illustrated in a non-limiting manner, the number of items of communicating equipment ECj is equal to three (j=1 to 3). But this number can take any value greater than or equal to two (2). The communication network RC includes, for example, a wired communication infrastructure, potentially personal, to which can connect the communicating equipment ECj and the computer apparatus AI.

More particularly, the persons have access to a user interface displayed by one or more items of communicating equipment EC1, EC2, EC3. As mentioned previously, these apparatuses may take the form of desktop or portable computers, tablets or any other electronic apparatus capable of being connected to a network. These items of equipment have notably a human/machine interface, such as for example a keyboard (potentially touch sensitive), a display screen enabling an interaction between the persons and the communicating equipment EC1, EC2, EC3. The user interface may be displayed by means of an internet browser on the display screen from information obtained from a computing apparatus AI, for example a remote server. The browser may for example make requests to said computing apparatus AI with the aid of an http or https type protocol. In order to facilitate exchanges, the computer apparatus AI may for example make available to client applications a programming interface 201 (API for Application Programming Interface), for example a REST type API. Alternatively, the user interface may be displayed by means of dedicated software on the display screen and may be specific to each platform, said dedicated software interacting with the API of the computer apparatus AI. Such software may for example take the form of a mobile application executed on a roaming apparatus such as a tablet or a smartphone.

The network RC used to carry out exchanges between the remote computer apparatus AI and the communicating equipment EC1, EC2 may be a local area network (LAN) type, a wide area network (WAN), Internet or a mobile network for example. The network RC may be of conventional type, wired or wireless, and may have different configurations including a star structure, a token ring configuration or instead other configurations. In certain embodiments, the network RC may be a peer-to-peer network. The network RC may also be coupled to or include parts of telecommunication networks so as to send and to receive a variety of different protocols. In certain embodiments, the network RC includes a Bluetooth communication network or a cellular communication network to send and receive data, notably by SMS (Short Message Service), MMS (Multimedia Messaging Service), http (hypertext transfer protocol), by direct connection, WAP (Wireless Application Protocol), e-mail, etc.

In certain embodiments the mobile network includes one or more wireless personal area networks, wireless local networks, wireless mesh networks, wireless metropolitan networks, wireless wide area networks and cellular networks. For example, the mobile network includes a Bluetooth communication network or a cellular communication network to send and to receive data, notably by SMS (Short Message Service), MMS (Multimedia Messaging Service), http (hypertext transfer protocol), by direct connection, WAP (Wireless Application Protocol), e-mail, etc.

The remote computer apparatus AI may take the form of a computer executing a Web server by means of a memory and a processor. The computer apparatus AI includes a communication system MC suited to being connected to at least one communication network RC. This communication system MC may take the form of one or more network cards, for example an Ethernet network card or a Wifi network card. Said Web server supplies the API 201 to the communicating equipment EC1, EC2, EC3 in order that the latter can display the user interface. The Web server may moreover execute a plurality of software modules 202, 203, 204, 205, 206, 207 such that these modules supply the data required for the operation of the API 201. The Web server may for example be a server of Apache type and the modules may be PHP modules supplying data to a REST API also realized in the form of a PHP module, the whole constituting a software layer CL.

The storage of the data required for the operation of the software modules of the Web server 202, 203, 204, 205, 206, 207 is ensured by a storage system or memory, for example a database. This database may be a database of NOSQL type, for example a MongoDB database. The database software may be executed on the same computing apparatus as the Web server. Alternatively, the database software may be executed on a different computing apparatus. In order to ensure the exchange between the software layer CL and the database software, the software layer CL includes database drivers enabling the exchange of data between the software modules 202, 203, 204, 205, 206, 207 of the software layer CL and the database. In certain embodiments, the memory may be a dynamic random access memory (DRAM), a static random access memory (SRAM), a flash memory or another type of memory. In certain embodiments, the memory also includes a non-volatile memory or another permanent storage means and a support including a hard disc, a floppy disk, a CD-ROM, a DVD-RAM reader, a DVD-RW, a flash memory or any other mass storage device for the storage of information in a more durable manner.

In order to supply data on users to the database, data integration software ID is also provided. This software may be executed on the same computing apparatus as the Web server. Alternatively, the data integration software ID may be executed on a different computing apparatus. The data integration software ID may submit via a http or https request data relative to the users, these data are subsequently processed by a software module 202, 203, 204, 205, 206 of the Web server in order to be stored in the database.

In order to carry out calculations specific to the invention, a distributed computing software or calculator CD, for example Spark software, is also provided. This software may be executed on the same computing apparatus as the Web server. Alternatively, the distributed computing software CD may be executed on a different computing apparatus. The distributed computing software or calculator CD includes drivers making it possible to connect to the database. The software layer CL includes the drivers necessary in order to interact with the distributed computing software CD. Thus, the software modules 202, 203, 204, 205, 206, 207 of the software layer CL can carry out calculations with the aid of the distributed computing software or calculator CD from data stored in the database. The processing system MT thus includes the software layer CL as well as the storage system or memory MS (here the database) and the distributed computing software or calculator CD.

The calculator CD includes an arithmetic logic unit, a microprocessor, a controller or another processor matrix making it possible to carry out calculations. The calculator is coupled (for example via buses) to other components of the computing system. Although FIG. 4 only shows one calculator, a plurality of calculators may also be provided.

The memory MS memorizes the instructions and/or the data capable of being executed by the calculator. The instructions and/or the data may include the computer code in order to implement the techniques described in the present description.

The software modules 202, 203, 204, 205, 206, 207 of the software layer may include:
a module 202 for processing actions, said module saving in the database data relative to the actions of individuals;
a module 203 for calculating the level of participation, said module calculating, from data stored in the database, the level of participation of a user;
a so-called Gamification module 204 that aims to bring a playful aspect to the use of the software and thus to increase the efficiency thereof;
a module 205 for estimating the adoption curve, said module aiming to estimate the adoption curve, from data stored in the database;
a recommendation module 206 enabling users to interact with each other;
an authentication module 207 enabling the authentication of users.

Each module 202-207 may be a software module including routines making it possible to carry out tasks and functions that are attributed to it; in an embodiment each module 202-207 may be a set of instructions executable by the calculator CD in order to supply the functionality or the functionalities associated with said module; in an embodiment, the instructions of each module 202-207 may be stored in the memory MS and may be accessible to the calculator CD.

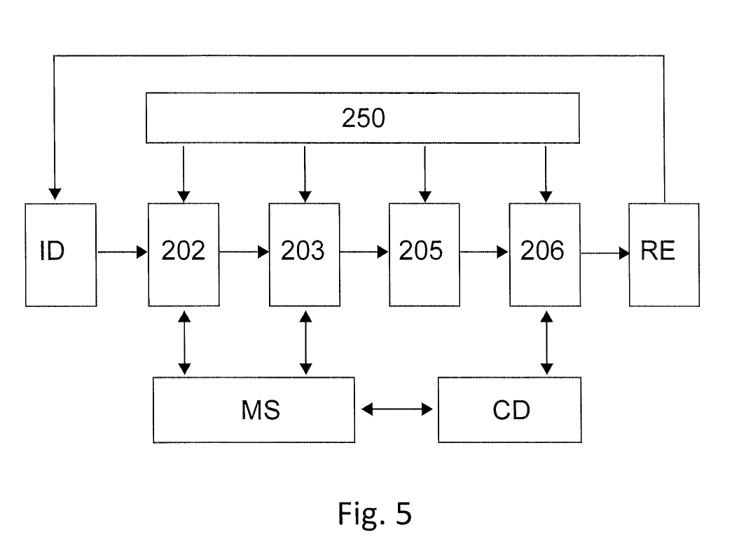

More particularly, as illustrated in FIG. 5, the software modules 202, 203, 204, 205, 206, 207 of the software layer interact together (and cooperate so as to supply recommendations of actions) and are driven by a software controller executed by the computer apparatus AI. The activity log of the individuals (for example, data users) is transmitted by the data integration software ID to the module 202 for processing actions, which integrates these data in the database. Subsequently, the module 203 for calculating the participation level calculates the participation level so as to measure the impact of the recommendation on the evolution of the participation level. Following this measure, the module 203 for calculating the participation level associates a score with the recommendations and saves the corresponding data in the database MS. Then, the module 205 for estimating the adoption curve classifies individuals on the adoption curve. Subsequently, the recommendation module 206 calculates an optimized recommendation RE. To do so, said recommendation module 206:
transforms the data contained in the database into a first format compatible with the distributed computing software CD;
calculates the correlation matrix with the aid of the distributed computing software CD;
calculates the weighting coefficients linked to the position of each individual on the adoption curve;
calculates the score of the possible recommendations with the aid of the distributed computing software CD.

Once the score for each correlation has been obtained, the recommendation module 206 establishes a classification of recommendations according to said score. Finally, said module 206 elaborates an optimized recommendation RE, this optimized recommendation being subsequently sent to the user interface. It is thus understood here that the processing systems MT include the software modules 202, 203, 204, 205, 206, 207 of the software layer CL as well as the storage system or memory MS (for example a database) and the distributed computing software CD (for example Spark software).

As mentioned above, the invention proposes implementing in an organization (here a firm), a method intended to enable the automatic determination of recommendation(s) of action(s) to make to persons of this organization during a deployment of a change. It ensues from the present description that this novel method provides better targeted recommendations and thus different from the recommendations that would have been obtained using a conventional approach.

Hereafter, it is considered, as a non-limiting example, that the firm is a network of vehicle dealerships, and that the change consists in the use by all salesmen of these dealerships of tablet computers to facilitate interaction with clients. But the invention is not limited to this type of change. It relates in fact to any modification made within an organization, in particular, but not only, in technical terms. Thus, it could be a modification intended to facilitate the carrying out of operations, or to make available innovations or new services or new functionalities, or to satisfy a new regulation or a new standard, or to impose the use of new software, or instead to introduce a new management system, for example of production or of personnel.

The method according to the invention includes first and second steps that may be implemented at least partially by the computer apparatus AI, and in particular by its processing systems MT.

It will be noted that the processing system MT is here realized in the form of a combination of software modules (or computing modules (or instead “software”)) and electronic circuits (or “hardware”). But in an embodiment variant it could be arranged in the form of software modules including at least one set of instructions executable by a processor of the computer apparatus AI. In this latter case the processing system MT constitutes a computer program product.

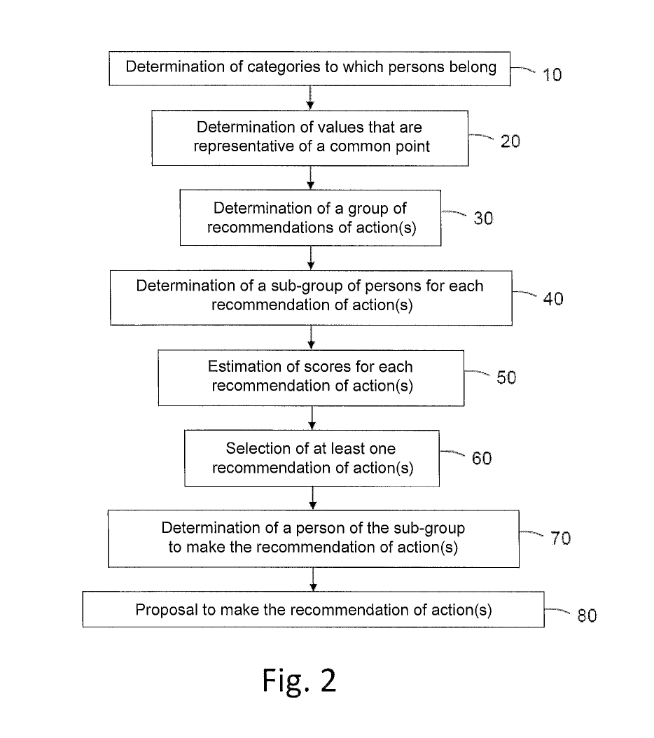

In the first step of the method according to the invention one (the processing system MT of the computer apparatus AI) begins firstly by determining, for each person of the organization concerned by the deployment of the change, a category to which he belongs taking account of a level of his participation in this deployment. This determination constitutes the sub-step referenced 10 in the example of algorithm for implementing the method illustrated in a non-limiting manner in FIG. 2.

The participation level of a person in the deployment may be determined by any means known to those skilled in the art, and in particular from data stored and representative of at least one activity of this person linked to the change. In an embodiment, the computing system AI receives data relative to each user RCj and representative of his activity by the network RC and memorizes these data in the storage system MS. Step 10 is implemented by the module 203 of the computing system AI. These data may, for example, be stored in the storage system MS forming part of the computer apparatus AI, and are preferentially updated either regularly (manually or automatically), or from the moment that an activity is detected or signaled automatically by (here) a tablet computer used (in the case of coupling of the latter to the computer apparatus AI via the communication network RC). For example, in an embodiment, each time that a user/member ECj uses his electronic device in accordance with a particular activity, data relative to the user/member and/or to the use of the electronic device are automatically sent to and received by the computing system AI and memorized in the storage system MS. As explained previously, the storage system MS may be arranged in the form of a memory or of a database, potentially of software type.

As a non-limiting example, when the change consists in using a tablet computer to present vehicles or vehicle options to clients, each new use of presentation by a salesman of his tablet computer may be counted, for example to obtain a daily or weekly use value, or to obtain a percentage increase in daily or weekly use.

Subsequently, one (the computing system MT with the aid of the module 203) determines values that are representative of a common point existing between a chosen person and each of the other persons of the organization. This other determination constitutes the sub-step referenced 20 in the example of algorithm of FIG. 2. Thus, as will be appreciated by those skilled in the art, the method according to an embodiment of the invention takes into account one or more dependency characteristics between users or members of the organization in order to determine recommendations of actions. The server network or computing system AI and its different modules are specially constructed and arranged to determine recommendations of actions using one or more dependency characteristics. Taking into account this or these characteristics, the network server or computing system AI delivers recommendations of actions which are different to those that would have been obtained using traditional methods of implementation of a change in an organization.

“Common point” is herein taken to mean any hardware or software element or used in parallel by two persons, any know relational element between two persons, any habit shared by two persons, or any type of belonging to a group, set, department or category, including without knowing it. It may thus be, for example, a relation of liking or friendship, or a habit or a common interest, such as for example use of a same service (such as for example posting messages on a social or company network or commenting on and/or disseminating a post) or of a same software or instead a same communication equipment, or a habit of participation in a same activity (professional, cultural, or sporting), or instead belonging (potentially without knowing it) to a department or to a category.

It will be noted that in this first step one (the processing system MT with the aid of the module 203) can determine at a given instant t for each person concerned by the deployment the category to which he belongs among at least four categories that correspond respectively to four different intervals of participation level in the deployment, which are defined by bounds that are a function of this given instant t.

For example, it is possible to have a first category C1 grouping together persons very reactive to the change, a second category C2 grouping together persons reactive to the change, a third category C3 grouping together persons moderately reactive to the change, a fourth category C4 grouping together persons slightly reactive to the change, and a fifth category C5 grouping together persons very little reactive to the change.

Among a set of persons, the breakdown percentages of these persons in the different categories may be known (and are data inputs/entries in the server network AI) and can make it possible to construct a curve of the evolution over time representative of the evolution over time of the deployment of a change, and for example flattened S (or sigmoid) shaped. A non-limiting example of theoretical curve cd of the evolution over time of the deployment of a change is illustrated in FIG. 3. In this example the five time intervals I1 to I5 correspond respectively to the phases during which persons belonging to the aforementioned five categories C1 to C5 really decide to accept the change by actively participating therein. The curve tends towards a horizontal asymptote which reflects total adoption (100%) of a change.

The sigmoid-shaped theoretical curve cd may be approximated by the equation:

cd=(1+e^{-(t-t0)/τ})⁻¹,

where t0 is the instant corresponding to half of the deployment and τ is a parameter representative of a time characteristic of the deployment. For example, this time τ may be representative of the value of the slope of the S-shaped curve at the instant t0 (situated in the part where it increases the most).

It will also be noted that in the first step one (the processing system MT with the aid of the modules 205) can determine for each person of the organization the category to which he belongs at a given instant t as a function of a difference between his participation level in the deployment at this given instant t and the value at this given instant t of the theoretical curve cd of the evolution over time of the deployment of the change.

It will be understood in fact that the greater this difference the more this indicates that the person i concerned is reticent to the change, and thus can make it possible to deduce the category to which this concerned person i belongs.

In a variant, the category to which each person of the organization belongs may be defined by stored data participating in a profile which is associated with him by the organization. For example, these data may be representative of a classification of each person within each category, potentially consecutively to the attribution of points (or analogues). These data may, for example, be stored in the storage system MS of the computer apparatus AI. They are preferentially updated regularly (manually or automatically).

It will also be noted that in the first step one (the processing system MT with the aid of the module 203) can, for example, determine the value that is representative of a common point existing between a chosen person and another person of the organization (potentially without them knowing each other), by a so-called Pearson correlation method. In this case, the determination may take place as a function of stored data which are representative of recommendations of action(s) for which the persons of the organization have shown a form of interest.

These data may, for example, be stored in the storage system MS of the computer apparatus AI. They are preferentially updated regularly (manually or automatically).

According to the Pearson correlation method, the value that is representative of a common point existing between two persons i and j may be considered as a distance. If Rᵢⱼ notes the set of recommendations of action(s) for which the persons i and j have shown a form of interest, and Sᵢₖ the score out of 100 (in terms of interest) of a person i for the recommendation of action(s) Rₖ, then the function f(i, j) giving the distance (or value) may be given by the formula:

$$f ( i , j ) = \frac{{\sum }_{k ∈ {R}_{ij}}^{ } ( {S}_{ik} - {\overline{S}}_{i} ) ( {S}_{jk} - {\overline{S}}_{j} )}{\sqrt{{\sum }_{k ∈ {R}_{ij}}^{ } {( {S}_{ik} - {\overline{S}}_{i} )}^{2}} \sqrt{{\sum }_{k ∈ {R}_{ij}}^{ } {( {S}_{jk} - {\overline{S}}_{j} )}^{2}}}$$

where Sᵢ is the average value of the score of the person i for all the recommendations of action(s).

For example, and in a non-limiting manner, the recommendations of action(s) contained in the list may be:
conversations (telephonic or not), one-to-one or in a group,
sending of posted messages (or “posts”) relative to the change considered, potentially the most popular and/or emanating from an influential person or having a status of referent person in the organization,
sending of boards containing information items representative of the deployment of the change considered, potentially the most popular, or emanating from an influential person or a person having a status of referent in the organization or that one normally follows (or listens to) or instead who is close in terms of interest for the posts or the boards, or associated with a group (or department),
participations in challenges.

It will be noted that, when the organization is subdivided into departments organized into hierarchies and each includes a manager and at least one person to manage (knowing that a manager may himself be managed by another manager belonging to a department situated upstream of his and being able to manage at least one other manager belonging to a department situated downstream of his), it is also possible to have recommendations of action(s) more specifically concerning managers and recommendations of action(s) more specifically concerning persons to manage. Thus, the recommendations of action(s) concerning more specifically persons to manage within a department will be preferentially relative to this department or to a department to follow or referent department, or to a person to follow or referent person, or to the manager of this department, or to other persons to manage forming part of this department. Similarly, the recommendations of action(s) concerning more specifically a manager will be preferentially relative to the department situated upstream of that which he runs, or to a department to follow or referent department, or to a person to follow or referent person, or his own manager, or to other persons to manage forming part of this department situated upstream.

In the second step of the method according to the invention one (the processing system MT of the computer apparatus AI with the aid of the module 206) begins by determining in a list a group of recommendations of action(s) to make to the chosen person i taking account of the category to which he belongs. This determination constitutes the sub-step referenced 30 in the example of algorithm of FIG. 2.

Subsequently, one (the processing system MT with the aid of the module 206) determines, for each recommendation of action(s) of the group (determined in the sub-step 30), among persons of the organization having an Important relationship with the recommendation of action(s) considered, a sub-group Gi of at the most a predefined number of persons j having the highest values (determined in the sub-step 20). This other determination constitutes the sub-step referenced 40 in the example of algorithm of FIG. 2.

For example, the predefined maximum number of persons j of a sub-group Gi may be chosen equal to one, two, three, five or ten, or even more, according to the number of persons belonging to the organization.

Subsequently, one (the processing system MT with the aid of the module 206) estimates, for each recommendation of action(s) of the group (determined in the sub-step 30), a score that is a function of the values that have been associated with the persons j belonging to the sub-group Gi (determined in the sub-step 20). This estimation constitutes the sub-step referenced 50 in the example of algorithm of FIG. 2.

In this case, each score Ŝᵢₖ of a recommendation of action(s) Rₖ may be estimated, from values taken by the function f(i, j) and from the selection of the closest sub-group of persons Gᵢ, by the following formula:

$${\hat{S}}_{ik} = {\overline{S}}_{i} + \frac{{\sum }_{j ∈ {G}_{i}}^{ } ( {S}_{jk} - {\overline{S}}_{j} ) f ( i , j )}{{\sum }_{j ∈ {G}_{i}}^{ } \vert f ( i , j ) \vert} .$$

In an embodiment variant, each score Ŝᵢₖ of a recommendation of action(s) Rₖ may be estimated as follows. Firstly, one (the processing system MT) can associate a weighting coefficient wⱼ with each person of the sub-group Gi (determined in the sub-step 20) as a function of the category to which he belongs and/or of a hierarchic level that he has within the organization and/or of a status that he has within the organization.

Each weighting coefficient wⱼ associated with a person j of the sub-group Gᵢ may, for example, be defined as a function of the instants tᵢ and tⱼ where the persons i and j have decided to participate really in the deployment of the considered change and the value taken by the theoretical curve cd at the considered instant. In this case, if tⱼ<min (tᵢ, t), wⱼ may be given by the formula:

$${w}_{j} = \frac{1}{1 + {e}^{- \frac{{t}_{j} - {\hat{t}}_{0}}{\hat{τ}}}} ,$$

and if tⱼ≧min (tᵢ, t), wⱼ=0.

Then, one (the processing system MT with the aid of the module 206) can estimate each score of each recommendation of action(s) of the group (determined in the sub-step 30) as a function of the values and weighting coefficients wⱼ associated with the persons j belonging to the sub-group Gi (determined in the sub-step 20).

In this variant, each score Ŝᵢₖ of a recommendation of action(s) Rₖ may be estimated by the following formula:

$${\hat{S}}_{ik} = {\overline{S}}_{i} + \frac{{\sum }_{j ∈ {G}_{i}}^{ } ( {S}_{jk} - {\overline{S}}_{j} ) {w}_{j} f ( i , j )}{{\sum }_{j ∈ {G}_{i}}^{ } {w}_{j} \vert f ( i , j ) \vert} .$$

Subsequently, one (the processing system MT with the aid of the module 206) selects among the recommendations of action(s) of the group (determined in the sub-step 30) at least that which has the highest score in order that it is made to the chosen person i. This selection constitutes the sub-step referenced 60 in the example of algorithm of FIG. 2.

It will be noted that it is possible to select several recommendations of action(s) within the group. For example, it is possible to select among the recommendations of action(s) of the group at least those that have the two highest scores.

It will also be noted, as illustrated in a non-limiting manner in FIG. 2, that in the second step, after having selected at least one recommendation of action(s), one (the processing system MT) can determine in the sub-group Gi (determined in the sub-step 20) at least one person suited to making this selected recommendation of action(s). This determination constitutes the sub-step referenced 70 in the example of algorithm of FIG. 2.

In this case, one (the processing system MT) may, for example, determine in the sub-group Gi (determined in the sub-step 20) at least one person as a function of the category to which he belongs and/or of a hierarchic level that he has within the organization and/or of a status that he has within the organization.

Thus, one can, for example, favor the choice of a person situated hierarchically just above the level of the person concerned in the organization and/or a person having a status of referent or person to follow (“leader” or model) and/or belonging to a category more receptive than that to which the person concerned belongs (and preferably classified just one level above).

Then, one (the processing system MT) can propose to each determined person to make this selected recommendation of action(s) to the chosen person i. This proposal constitutes the sub-step referenced 80 in the example of algorithm of FIG. 2.

A proposal may be made in an automated manner to the communicating equipment ECj of the determined person when the computer apparatus AI is arranged in the form of a server and includes, as illustrated, a communication system MC suited to being connected to the communication network RC in order to establish communications with the communicating equipment ECj used by the persons of the organization. In fact, in this case the processing system MT is arranged, after having selected a recommendation of action(s) and having determined in the sub-group Gi at least one person suited to making this selected recommendation of action(s), to order the communication system MC to transmit via the network RC to each determined person a message containing a proposal to make this selected recommendation of action(s) to the chosen person i.

In order to motivate the persons selected to make a proposed recommendation of action(s), it is possible to provide a reward mechanism, for example by points and/or by badge(s). The counting of these points and/or badge(s) may subsequently, for example, give a score, then a classification. Subsequently, it is possible, for example, to define the status of a person as a function of his classification.

In a variant or as a complement, in the second step, after having selected a recommendation of action(s), one (the processing system MT) can propose the latter to the chosen person i so that he follows it. As a non-limiting example, this recommendation of action(s) may be proposed to the chosen person i due to the fact that it has had a positive effect or aroused an interest in a person of the sub-group Gi.

This proposal to the chosen person i can be made automatically to his communicating equipment ECj when the computer apparatus AI is arranged in the form of a server and includes, as illustrated, a communication system MC suited to being connected to the communication network RC in order to establish communications with the communicating equipment ECj used by the persons of the organization. In fact, in this case the processing system MT is arranged, after having selected a recommendation of action(s) for the chosen person i, to order the communication system MC to transmit to this chosen person i a message containing a proposal to follow (or to make) this selected recommendation of action(s).

In order to motivate the chosen person i to follow (or to make) a proposed recommendation of action(s), it is possible to provide a reward mechanism, for example by points and/or by badge(s). The counting of these points and/or badge(s) may subsequently, for example, give a score, then a classification. Subsequently, it is possible, for example, to define the status of a person as a function of his classification.

It will be understood that each recommendation of action(s) made by a selected person to a chosen person i or instead proposed to a chosen person i is intended to try to convince the latter (i) to participate actively in the deployment of the considered change (and thus to adopt this change). In other words, the application of the method described above at chosen instants to each person concerned by a change within an organization is intended to make it possible to make, as quickly as possible, the real curve of the evolution over time of the deployment of the change tend towards the theoretical curve cd.

It will be noted that the processing system MT may also be arranged to estimate the reaction (acceptance or refusal) of a chosen person i when he is exposed to a recommendation of action(s). This option is intended to model the behavior of this chosen person i in order to be able later to better determine each recommendation of action(s) capable of convincing him to participate in the deployment of another change.

The invention is not limited to the embodiments of method and computing apparatus described above, only as an example, but it encompasses all the variants that those skilled in the art could envisage in the sole scope of the claims hereafter.

The method according to the invention is capable of finding other applications in extremely varied fields. For illustration purposes the following may be cited:
the field of the management of technical incidents with the search for ad hoc recommendations on the processes to follow;
the field of energy with the adaptation of operators using telemetry tablets when reading smart meters.

In the above description, for explanation needs, numerous details are specified in order to enable a good understanding of the specifications. However, it will be apparent to those skilled in the art that the invention may be realized without these specific details. In other embodiments, the architectures and devices are illustrated with the aid of block diagrams in order not to overload or obscure the description. For example, the present invention is described in an embodiment essentially while making reference to user interfaces and specific computer hardware. However, the present description applies to any type of computing devices capable of receiving data and commands, and any external device supplying a service. In the present description, the references to “an embodiment” or “this embodiment” signifies that a characteristic or a particular structure described in relation with the embodiment is included at least in one embodiment of the invention.

Certain parts of the preceding detailed description are presented in terms of algorithm and symbolic representations of operations on portions of data within a computer memory. These algorithmic descriptions and these representations of operations are the means used by those skilled in the art in the technique of processing data to transmit the content of their work to others of the field skilled in the art. An algorithm is here, and generally speaking, designed so as to constitute a sequence of self-sufficient steps leading to the desired result. The steps are those requiring the physical manipulation of physical quantities. Normally, and even though this is not necessary, these quantities take the form of electrical or magnetic signals capable of being stored, transferred, combined, compared, or manipulated in any manner. It has been considered more practical in certain passages, principally for reasons of common usage, to refer to these signals by the words bits, values, elements, symbols, letters, terms, numbers or words similar to the latter.

It is however important to keep in mind that these terms and similar terms are to be associated with the appropriate physical quantity and only constitute terms used to name these physical quantities. Unless it is specified otherwise in the present description, it will be understood that, throughout the description, the parts of the description that make use of terms including “processing”, “calculation”, “operation” or “determination”, “display” or similar terms refer to actions, methods or operations of a computing system, or a similar electronic calculation device which manipulates and transforms data represented as physical quantities (electronic) within the register and the memory of the computing system into other data also represented as physical quantities (electronic) within the register and the memory of the computing system or any other data storage, transmission or display device.

The present invention also relates to an apparatus carrying out the operations described in the present description. This apparatus is designed and constructed specifically for the needs of the invention or instead includes a computer program stored in the computer. Such a computer program may be stored in a computer storage support that can be read by a computer including any type of disc notably floppy disc, optical disc, CDROM, magnetic disc, read only memory (ROM), random access memory (RAM), an EPROM, an EEPROM, optical or magnetic cards, flash memories including USB keys with a non-volatile memory or any other support suited to the storage of computing data or instructions, these supports being coupled to the bus of the computing system.

The present invention may take the form of an entirely hardware implementation, an entirely software implementation or an implementation including both hardware and software elements, which include but are not limited to microcodes, internal software or embedded software, etc.

In addition, the present invention may take the form of a computer program product stored on a data support readable or useable by a computer and on which are stored the program instructions in order to be used by or in conjunction with a computer or any other system capable of executing said Instructions. For the needs of the description, a computer support readable by a computer can take the form of any apparatus capable of containing, storing, communicating, transmitting, or transporting the program in order to be used by or in conjunction with a computer or any other system capable of executing said instructions.

A data processing system adapted to store and/or execute the program code includes at least one processor coupled directly or indirectly to memory elements through a bus system. The memory elements may include a local memory used for the actual execution of the program code, a memory for mass storage, and a cache memory that supplies a temporary storage of at least one part of the program code in order to reduce the number of times where the code must be read from the mass storage memory during the execution of said program code.

The input/output devices (I/O devices) including but not being limited to keyboards, display screens, mice (or any other pointing device) may be coupled to the system either directly or indirectly via input/output controllers.

Network adaptors may also be coupled to the system to enable the processing system to be coupled to other processing systems, or to remote printers, or to a storage device through a public or personal network. Modems and Ethernet cards are only some examples of available network adaptors.

Finally, the present invention is not described in referring to any computer language. It will be obvious to those skilled in the art that a large variety of languages may be used in order to implement the teachings of the present description.

In the preceding description, embodiments of specifications have been presented for the purposes of illustration and description. This description does not aim to be exhaustive and is thus not limited to the only embodiments such as they are described. Numerous modifications and/or variations may be envisaged In the light of the preceding description. It is thus obvious that the scope of the application is not limited to the detailed description of the invention but rather to the subject matter of the claims of this application. It is thus understood by those skilled in the art that the present invention may include other forms of embodiment without all the same moving away from the spirit or essential characteristics of the invention. Similarly, the mechanisms implementing the invention or these characteristics may have different names, divisions and/or format. In addition, it will appear to those skilled in the art that the modules, the routines, the characteristics or the attributes of the invention may be implemented in a software or hardware manner, by microcode or a combination of the three. In addition, each time that a component, for example a module, of the invention is implemented in a software manner, said component may be implemented by an autonomous software, a part of a larger program, a plurality of independent programs, a library linked in a static or dynamic manner, a module of the kernel chargeable in said kernel, a device driver and/or any other system known now or in the future by those skilled in the art of software programming. In addition, the present invention is in no way limited to an implementation in a specific language, to a specific operating system or a particular computer environment. Thus, the present description has the aim of illustrating and in no way limiting the scope of the present application, which is detailed in the claims that follow.

1. A method for automatically determining recommendation(s) of action(s) to make to persons of an organization during a deployment of a change, the method comprising a first step in which one determines for each person, with a processing system of a computing apparatus arranged in the form of a server including a communication system suited to being connected to a communication network in order to establish communications with the communicating equipment (ECj) used by said persons, at a given instant, a category to which he belongs as a function of a difference between his participation level in said deployment at this given instant and a value at this given instant of a theoretical curve of the evolution over time of said deployment of the change, then values representative of a common point existing between a chosen person and each of the other persons of said organization, and a second step in which one determines in a list, with said processing system, a group of recommendations of action(s) to make to said chosen person taking account of the category to which he belongs, then for each recommendation of action(s) of said group one determines, with said processing system, among persons having an interest for this recommendation above a first threshold value and a proximity with the chosen person above a second threshold value a sub-group of at the most a predefined number of persons having said highest values, then one estimates, with said processing system, for each recommendation of action(s) of said group a score as a function of said values associated with the persons belonging to said determined sub-group, then one selects, with said processing system, among said recommendations of action(s) of said group at least that having the highest score in order that it is made in an automated manner to the communication equipment of said chosen person.

2. The method according to claim 1, wherein in said first step one determines, with said processing system, at a given instant for each person the category to which he belongs among at least four categories corresponding respectively to four different intervals of participation level in said deployment, defined by bounds as a function of said given instant.

3. The method according to claim 1, wherein said theoretical curve of the evolution over time of the deployment of the change is defined by the equation cd=(1+e^{-(t-t0)/τ})⁻¹, where t0 is an instant corresponding to half of said deployment and τ is a parameter representative of a time characteristic of said deployment.

4. The method according to claim 1, wherein in said first step each value, representative of a common point existing between a chosen person and another person of said organization, is determined by said processing system by a Pearson correlation method as a function of stored data representative of recommendations of action(s) for which said persons of the organization have shown a form of interest.

5. The method according to, claim 1 wherein in said second step one selects, with said processing system, among said recommendations of action(s) of said group at least those having the two highest scores.

6. The method according to, claim 1 wherein in said second step, after having selected a recommendation of action(s), one determines, with said processing system, in said sub-group at least one person suited to making this selected recommendation of action(s), then one proposes, with said processing system, to each determined person to make this selected recommendation of action(s) to said chosen person.

7. The method according to, claim 1 wherein in said second step, after having selected a recommendation of action(s), it is possible to propose, with said processing system, the latter to said chosen person so that he follows it.

8. The method according to claim 1, wherein in said second step one determines, with said processing system, in said sub-group at least one person as a function of the category to which he belongs and/or of a hierarchic level that he has within said organization and/or of a status that he has within said organization.

9. The method according to, claim 1 wherein in said second step one associates, with said processing system, a weighting coefficient with each person of said sub-group as a function of the category to which he belongs and/or of a hierarchic level that he has within said organization and/or of a status that he has within said organization, and one estimates, with said processing system, each score of each recommendation of action(s) of said group as a function moreover of said weighting coefficients associated with said persons of said sub-group.

10. A computer program product including a set of instructions which, when it is executed by a computer, is suited to implementing the method according to claim 1 to determine automatically recommendations of action(s) to make to persons of an organization during a deployment of a change.

11. A computing apparatus, comprising a processing system arranged, in the presence of an organization including persons involved in a deployment of a change:
to determine for each person at a given instant, a category to which he belongs as a function of a difference between his participation level in said deployment at this given instant and a value at this given instant of a theoretical curve of the evolution over time of said deployment of the change, then values representative of a common point existing between a chosen person and each of the other persons of said organization,
then to determine in a list a group of recommendations of action(s) to make to said chosen person taking account of the category to which he belongs,
then for each recommendation of action(s) of said group to determine among persons having an interest for this recommendation above a first predetermined value and a proximity with the chosen person above a second predetermined value a sub-group of at the most a predefined number of persons having said highest values,
then to estimate for each recommendation of action(s) of said group a score as a function of said values associated with the persons belonging to said determined sub-group,
then to select among said recommendations of action(s) of said group at least that having the highest score in order that it is made to said chosen person,
said apparatus being arranged in the form of a server further including a communication system suited to being connected to a communication network in order to establish communications with the communicating equipment used by said persons, and wherein said processing system is arranged, after having selected a recommendation of action(s), to determine in said sub-group at least one person suited to making this selected recommendation of action(s), then to order said communication system to transmit to each determined person a message containing a proposal to make this selected recommendation of action(s) to said chosen person, said recommendation being made in an automated manner to the communicating equipment of said chosen person.

12. A computer implemented process for automatically determining one or more recommendations of actions to a plurality of members of an organization during implementation of a change in the organization, the process comprising:
receiving data, by a computer system, related to the plurality of members, said data being representative of a participation level of each member to the change in the organization;
selecting for each member, by the computer system, using said data, one predetermined category in which said member belongs, said predetermined category being selected among a plurality of predetermined categories and based upon a difference, at a given instant, between the participation level of said member and a value of a reference function representative of a temporal evolution of said change;
determining, by the computer system, values that are each representative of a common point between said member and the other members of said organization;
selecting, by the computer system, a group of recommendations of actions for said member based upon the selected predetermined category;
for each recommendation of the group of recommendations of actions, determining, by the computer system, among members having an interest for said recommendation that is greater than a first threshold value and a proximity with said member that is greater than a second threshold value, a sub-group of said members;
for each recommendation of the group of recommendations of actions, determining, by the computer system, a score;
selecting, by the computer system, among the recommendations of actions of the group, the recommendation that has the highest score, and
sending, by the computer system, the selected recommendation to the member.
